(19) United States
(12) Patent Application Publication
(10) Pub. No.: US 2022/0270249 A1
(43) Pub. Date: Aug. 25, 2022

(54) NUTRIENT DEFICIENCY DETECTION AND FORECASTING SYSTEM

(71) Applicant: Intelinair, Inc., Champaign, IL (US)

(72) Inventors: Saba Dadsetan, Champaign, IL (US); Gisele Rose, Champaign, IL (US); Naira Hovakimyan, Champaign, IL (US); Jennifer Hobbs, Champaign, IL (US)

(73) Assignee: Intelinair, Inc., Champaign, IL (US)

(21) Appl. No.: 17/676,474

(22) Filed: Feb. 21, 2022

Related U.S. Application Data
(60) Provisional application No. 63/151,141, filed on Feb. 19, 2021.

(51) Int. Cl. G06T 7/00; G06T 7/10; G06T 3/40

(52) U.S. Cl. CPC G06T 7/0012; G06T 7/10; G06T 3/4038; G06T 2207/20132; G06T 2207/20084; G06T 2207/30188

(57) ABSTRACT

A nutrient deficiency detection system including an image gathering unit that gathers at least one representation of a field and stiches the images together to produce a large single image of the field, an image analysis unit that identifies areas of nutrient deficiency in the field, and a deficiency analysis unit processes and calculates an effect on the yield of the field based on the nutrient deficiency.

### CROSS REFERENCE TO RELATED APPLICATIONS

This is application claims the benefit of and priority from U.S. Application Ser. No. 63/151,141, filed Feb. 19, 2021, which is fully incorporated herein by reference.

### BACKGROUND OF THE INVENTION

A rising area of interest for the application of deep learning approaches is agriculture. Computer vision approaches and applications in agriculture simultaneously address key social needs while furthering our understanding of the field by addressing unique theoretical and computational challenges.

One area of concern in agriculture is nutrient deficiency stress in plants. Once nutrient deficiency stress has set in, crops are unable to mature to full maturity resulting in a loss of yield. If nutrient deficiency is detected early, the process can be reversed resulting in higher yields. Therefore, a need exists for a system that can detect plant nutrient deficiency early.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a nutrient deficiency detection system including an image gathering unit that gathers at least one representation of a field and stiches the images together to produce a large single image of the field, an image analysis unit that identifies areas of nutrient deficiency in the field, a deficiency analysis unit processes and calculates an effect on the yield of the field based on the nutrient deficiency.

In another embodiment, the image analysis unit retrieves at least one image of the field that was taken at an earlier time.

In another embodiment, the image analysis unit analyses the gathered image and the at least one retrieved image in parallel.

In another embodiment, the image analysis unit passes each image through a UNet processor to produce a binary mask.

in another embodiment, the image analysis unit stacks and processes the binary mask through a convolutional LSTM processor.

In another embodiment, the image analysis unit compares at least one area of nutrient deficiency in the gathered image with the at least on retrieved image of the at least on area to determine the progression of nutrient deficiency in the at least one identified area.

In another embodiment, the areas of nutrient deficiency are associated with a geolocation transmitted to a piece of equipment to rectify the nutrient deficiency.

In another embodiment, the gathered image is cropped using a wise cropping method.

In another embodiment, the gathered image is cropped based on an identification of a potential nutrient deficiency area in the image.

In another embodiment, the gathered image is cropped to 512 pixels by 512 pixels.

Another embodiment of the present disclosures includes a method of identifying nutrient deficiencies including the steps of gathering at least one representation of a field and stiches the images together to produce a large single image of the field, identifying areas of nutrient deficiency in the field, processing and calculating an effect on the yield of the field based on the nutrient deficiency.

Another embodiment includes the step of retrieving at least one image of the field that was taken at an earlier time.

Another embodiment includes the step of analyzing the gathered image and the at least one retrieved image in parallel.

Another embodiment includes the step of passing each image through a UNet processor to produce a binary mask.

Another embodiment includes the step of stacking and processing the binary mask through a convolutional LSTM processor.

Another embodiment includes the step of comparing at least one area of nutrient deficiency in the gathered image with the at least on retrieved image of the at least on area to determine the progression of nutrient deficiency in the at least one identified area.

Another embodiment includes the step of associating the areas of nutrient deficiency with a geolocation transmitted to a piece of equipment to rectify the nutrient deficiency.

Another embodiment includes the step of cropping the gathered image using a wise cropping method.

Another embodiment the gathered image is cropped based on an identification of a potential nutrient deficiency area in the image.

Another embodiment includes copping the gathered image to 512 pixels by 512 pixels.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a nutrient analysis system consistent with the present invention;

FIG. 2 depicts one embodiment of a nutrient analysis unit;

FIG. 3 depicts one embodiment of a communication device consistent with the present invention;

FIG. 4 depicts a schematic representation of a process used to analyze the nutrient deficiency of areas in a field;

FIG. 5 a schematic representation of a process used to compare nutrient levels in different areas of a field;

FIG. 6 depicts a schematic representation of identifying areas of nutrient deficiency in a field;

FIG. 7 depicts a schematic representation of a model architecture for detection of nutrient deficiency areas in an image.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

The nutrient analysis system 100 gathers images from a drone aircraft flying at a low altitude. Each image is stitched together with adjacent images to provide single large scale view of the field where the specialty crops are being, or have been, grown The system performs a series of steps to identify areas of nutrient deficiency in the images and determines the impact of the deficiency on potential yields.

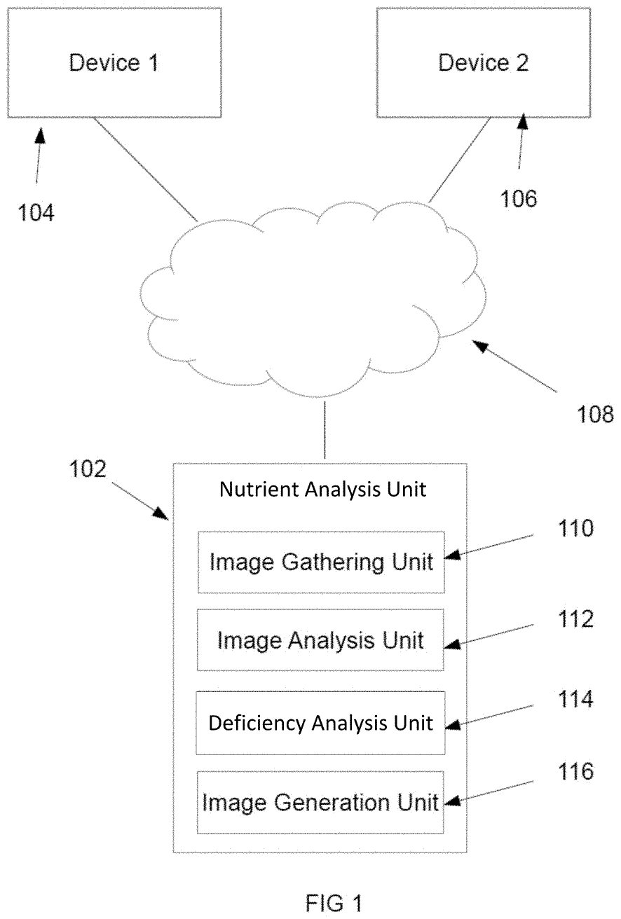

FIG. 1 depicts one embodiment of a nutrient analysis system 100 consistent with the present invention. The nutrient analysis system 100 includes a nutrient analysis unit 102, a communication device #1 104, a communication device #2 106 each communicatively connected via a network 108. The nutrient analysis unit 102 further includes an image gathering unit 110, an image analysis unit 112, a deficiency analysis unit 114 and an image generation unit 116.

The image gathering unit 110 and image analysis unit 112 may be embodied by one or more servers. Alternatively, each of the deficiency analysis unit 114 and image generation unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the nutrient analysis unit 102 may be servers, workstations, network appliances or any other suitable data storage devices. In another embodiment, the communication devices 104 and 106 may be any combination of cellular phones, telephones, personal data assistants, or any other suitable communication devices. In one embodiment, the network 108 may be any private or public communication network known to one skilled in the art such as a local area network (“LAN”), wide area network (“WAN”), peer-to-peer network, cellular network or any suitable network, using standard communication protocols. The network 108 may include hardwired as well as wireless branches. The image gathering unit 112 may be a digital camera. In one embodiment, the image gathering unit 112 is a three band (RGB) camera.

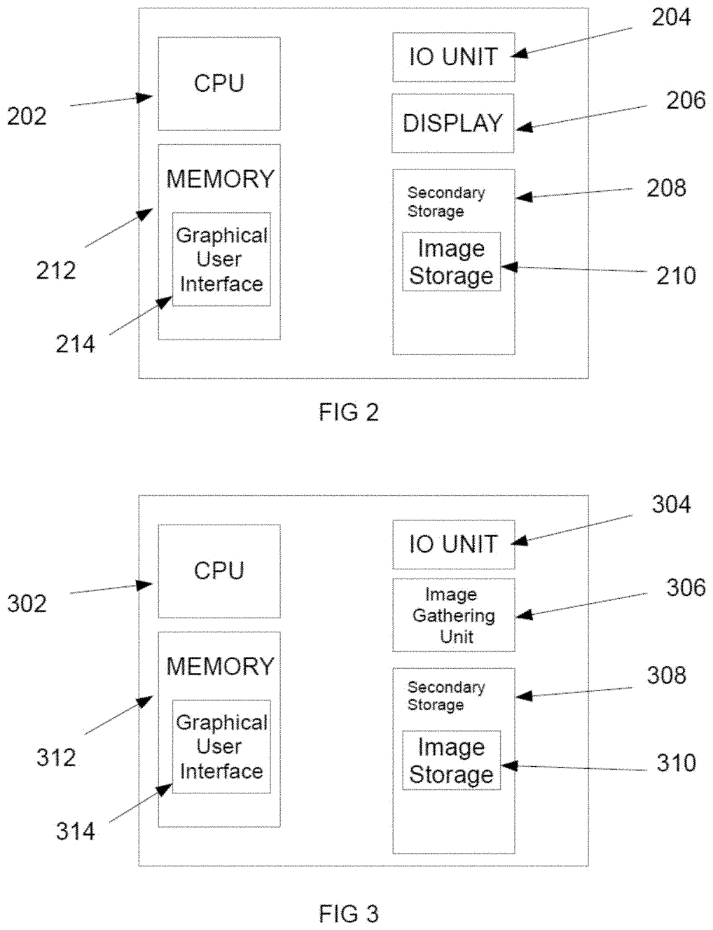

FIG. 2 depicts one embodiment of a nutrient analysis unit 102. The nutrient analysis unit 102 includes a network I/O device 204, a processor 202, a display 206 and a secondary storage 208 running image storage unit 210 and a memory 212 running a graphical user interface 214. The image gathering unit 112, operating in memory 208 of the residue analysis unit 102, is operatively configured to receive an image from the network I/O device 204. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The deficiency analysis unit 114 may be a compiled program running on a server, a process running on a microprocessor or any other suitable port control software.

FIG. 3 depicts one embodiment of a communication device 104/106 consistent with the present invention. The communication device 104/1106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

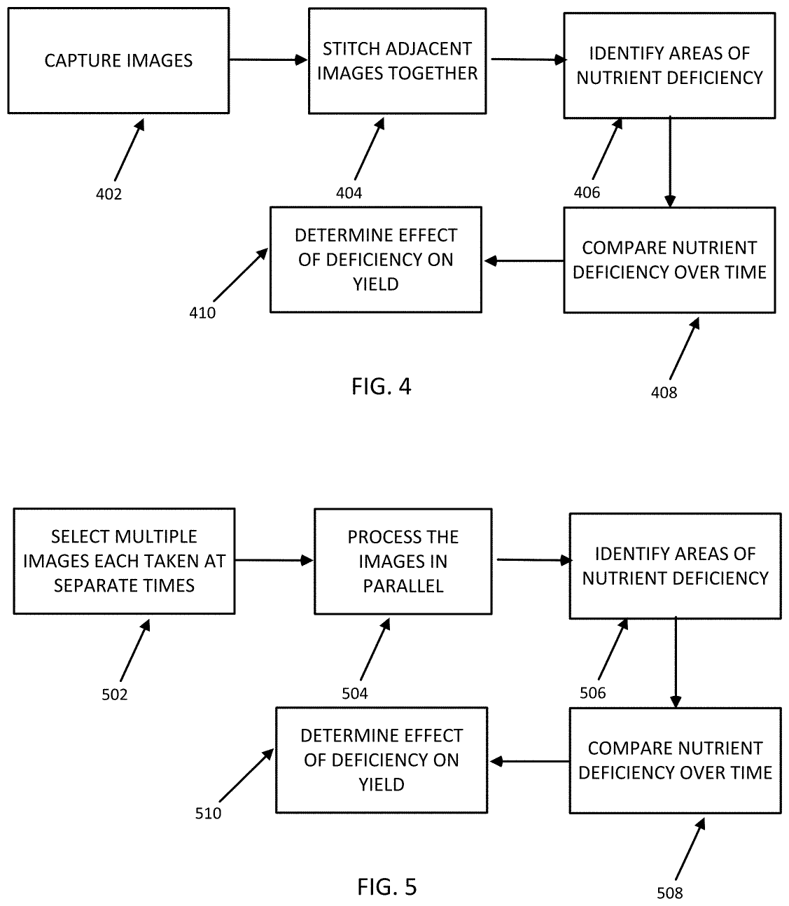

FIG. 4 depicts a schematic representation of a process used to analyze the nutrient deficiency of areas in a field. In step 402, the image gathering unit 110 gathers an image of a field. In one embodiment, the image is captured from a low flying aircraft. In step 402, the captured images are mosaiced together to form a single image of a field. In step 404, the deficiency analysis unit 114 identifies potential areas of nutrient deficiencies in each image. In step 406, the deficiency analysis unit 114 compares the areas of potential nutrient deficiency with past images to determine a change in the nutrient levels of the identified areas. In step 408, the deficiency analysis unit 114 determines a potential effect on crop yield based on the deficiency analysis.

FIG. 5 is a schematic representation of a process used to compare nutrient levels in different areas of a field. In step 502, the deficiency analysis unit 114 retrieves multiple images of a field taken at different times. In step 504, each image is processed in parallel. In one embodiment, each image is passed through a UNet processor to produce a binary mask, which is then stacked and processed through a convolutional LSTM processor. In step 506, the deficiency analysis unit 114 analyzes the processed image to determine areas of nutrient deficiency. In step 508, the image analysis unit 114 compares the areas of nutrient deficiency with prior images of the areas to determine the progression of nutrient deficiency in the identified areas. In step 510, the deficiency analysis unit 114 determines the effect on crop yield based on the progression of nutrient deficiency.

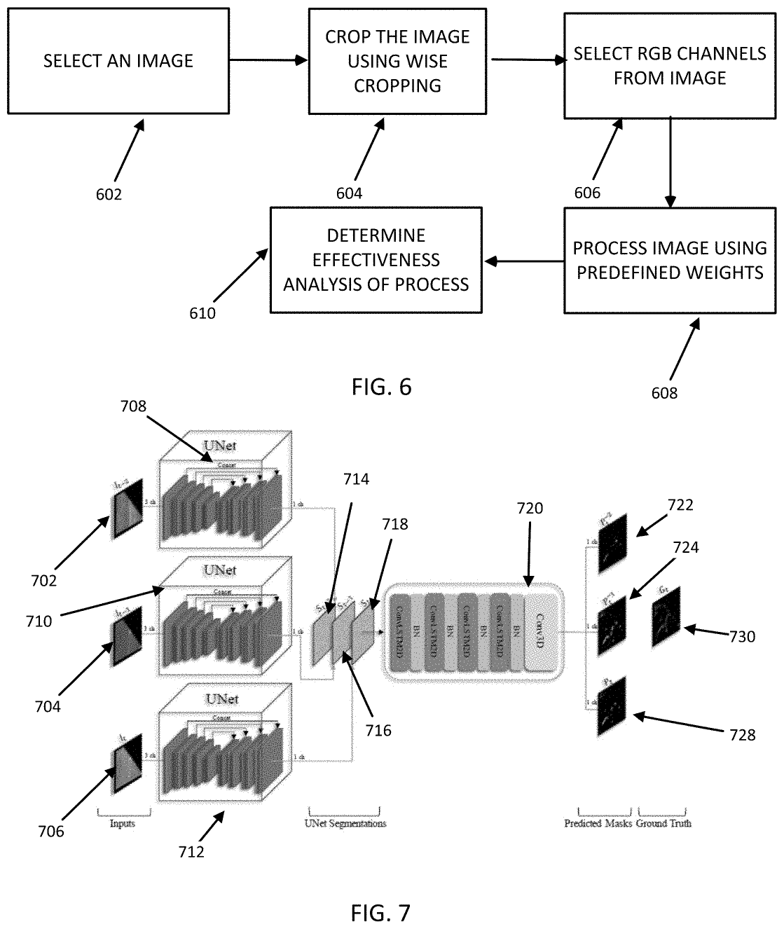

FIG. 6 depicts a schematic representation of identifying areas of nutrient deficiency in a field. In step 602, an image is selected for analysis. In step 604, the image is cropped using a wise cropping method. In one embodiment, the image is cropped based on the identification of potential nutrient deficiency areas in the image. In one embodiment, the image is cropped to 512×512 pixels. In step 606, the RGB channels from the image are selected for processing. In step 608, the image is processed using predefined weights. In one embodiment, the image is processed using pretrained ImageNet weights. In step 610, the image is further processed to determine the effectiveness of the processing based on comparable known areas of nutrient deficiencies in the image.

FIG. 7 depicts a schematic representation of a model architecture for detection of nutrient deficiency areas in an image. Three images of a field 702, 704 and 706 are gathered over different timeframes. Each image 702, 704 and 706 is processed through parallel UNet processors 708, 710 and 712. To generate separate single channel outputs 714, 716 and 718. The single channel outputs 714, 716 and 718 are stacked and passed through a convolutional LSTM layer 720 to generate prediction images 722, 724 and 726 which are then compared to a reference image 728 to determine areas of nutrient deficiency in the field. In one embodiment, the areas of nutrient deficiency may be associated with a geolocation that can be sent to equipment to rectify the nutrient deficiency.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A nutrient deficiency detection system including:
an image gathering unit that gathers at least one representation of a field and stiches the images together to produce a large single image of the field;
an image analysis unit that identifies areas of nutrient deficiency in the field;
a deficiency analysis unit processes and calculates an effect on the yield of the field based on the nutrient deficiency.

2. The nutrient deficiency detection system of claim 1, wherein the image analysis unit retrieves at least one image of the field that was taken at an earlier time.

3. The nutrient deficiency detection system of claim 2, wherein the image analysis unit analyses the gathered image and the at least one retrieved image in parallel.

4. The nutrient deficiency detection system of claim 3, wherein the image analysis unit passes each image through a UNet processor to produce a binary mask.

5. The nutrient deficiency detection system of claim 4, wherein the image analysis unit stacks and processes the binary mask through a convolutional LSTM processor.

6. The nutrient deficiency detection system of claim 5, wherein the image analysis unit compares at least one area of nutrient deficiency in the gathered image with the at least on retrieved image of the at least on area to determine the progression of nutrient deficiency in the at least one identified area.

7. The nutrient deficiency detection system of claim 6, wherein the areas of nutrient deficiency are associated with a geolocation transmitted to a piece of equipment to rectify the nutrient deficiency.

8. The nutrient deficiency detection system of claim 1, wherein the gathered image is cropped using a wise cropping method.

9. The nutrient deficiency detection system of claim 8, wherein the gathered image is cropped based on an identification of a potential nutrient deficiency area in the image.

10. The nutrient deficiency detection system of claim 8, wherein the gathered image is cropped to 512 pixels by 512 pixels.

11. A method of identifying nutrient deficiencies including the steps of:
gathering at least one representation of a field and stiches the images together to produce a large single image of the field;
identifying areas of nutrient deficiency in the field;
processing and calculating an effect on the yield of the field based on the nutrient deficiency.

12. The method of claim 11, including the step of retrieving at least one image of the field that was taken at an earlier time.

13. The method of claim 12, including the step of analyzing the gathered image and the at least one retrieved image in parallel.

14. The method of claim 13, including the step of passing each image through a UNet processor to produce a binary mask.

15. The method of claim 14, including the step of stacking and processing the binary mask through a convolutional LSTM processor.

16. The method of claim 15, including the step of comparing at least one area of nutrient deficiency in the gathered image with the at least on retrieved image of the at least on area to determine the progression of nutrient deficiency in the at least one identified area.

17. The method of claim 16, including the step of associating the areas of nutrient deficiency with a geolocation transmitted to a piece of equipment to rectify the nutrient deficiency.

18. The method of claim 11, including the step of cropping the gathered image using a wise cropping method.

19. The method of claim 18, wherein the gathered image is cropped based on an identification of a potential nutrient deficiency area in the image.

20. The method of claim 18, wherein the gathered image is cropped to 512 pixels by 512 pixels.
